(19) United States
(12) Patent Application Publication
(10) Pub. No.: US 2023/0182592 A1
(43) Pub. Date: Jun. 15, 2023

(54) Electric Connector for High Power Charging

(71) Applicant: ABB E-mobility B.V., Delft (NL)

(72) Inventors: Francisco Garcia-Ferre, Baden (CH); Lilian Kaufmann, Birmenstorf (CH); Pedram Kheiri, Hausen (CH); Stefan Raaijmakers, Delft (NL); Wiebe Zoon, Delft (NL)

(73) Assignee: ABB E-mobility B.V., Delft (NL)

(21) Appl. No.: 18/077,018

(22) Filed: Dec. 7, 2022

(30) Foreign Application Priority Data
Dec. 9, 2021 (EP) 21213402.7

(51) Int. Cl. B60L 53/16; B60L 53/302; H01R 13/03; H01R 13/639

(52) U.S. Cl. CPC B60L 53/16; B60L 53/302; H01R 13/03; H01R 13/639; H01R 2201/26

(57) ABSTRACT

An electric connector includes a connector body having a connector core and two protruding cuboidal elements that, together, form a U shape. At least one conducting element is arranged at an inner side of the protruding cuboidal element. The conducting element protrudes, at least partly, from the inner side. The conducting element is arranged slidably between two notches, which are arranged in the cuboidal element. The conducting element and at least one notch of the two are configured for conducting charging current.

### CROSS-REFERENCE TO RELATED APPLICATIONS

This patent application claims priority to European Patent Application No. 21213402.7, filed on Dec. 9, 2021, which is incorporated herein in its entirety by reference.

### FIELD OF THE DISCLOSURE

The present disclosure relates to electric connectors, particularly for high power charging of, e.g., electric vehicles, and to a method for the use of such electric connectors.

### BACKGROUND OF THE INVENTION

Charging connectors may be used for charging electric vehicles, but are not limited to that application. Conventional charging connectors may, in many cases, be limited to a maximum current of about 500 A. However, there may be a need for charging connectors that are able to deal with higher currents. Those charging connectors may have higher requirements, for instance concerning their maintainability.

### BRIEF SUMMARY OF THE INVENTION

In a general aspect, the present disclosure describes a charging connector, particularly with an improved maintainability.

One aspect of the disclosed embodiments relates to an electric connector for high power charging, the connector comprising a connector body, comprising a connector core and two protruding cuboidal elements, the connector core and the two protruding cuboidal elements forming a rectangular U, and at least one conducting element, arranged at an inner side of the protruding cuboidal element, wherein the conducting element protrudes, at least partly, from the inner side, and wherein the conducting element is arranged slidably between two notches, the notches arranged in the cuboidal element, and wherein the conducting element and at least one notch of the notches are configured for conducting charging current.

The electric connector for high power charging is designed for being able to conduct currents of more than 500 A. At least in some embodiments, the electric connector may be able of delivering a maximum current of about 3 kA and a voltage of about 1.5 kV; however, there may be embodiments that may be configured for lower powers, which may include a maximum current of less than 500 A. The electric connector may, for instance, be used for charging heavy vehicles (e.g. trucks, vessels or aircraft), but may also be used for devices that need high power, such as motors or electric buffers.

Inside the connector, a connector body is arranged. The connector body is configured for supporting a transport of current. The connector body may have any form, e.g. a cubic block, a cylinder, or may be of another form. The connector core and two protruding cuboidal elements form a rectangular U. The rectangular U may have rounded corners. The rectangular U may be configured for surrounding a conducting structure, at least by the two protruding cuboidal elements, which may be configured for touching the conducting structure at least laterally. The conducting structure may act as a mechanical and/or electrical counterpart for the protruding cuboidal elements. The conducting structure may be arranged in or on a vehicle. The two protruding cuboidal elements may have an electric contact or conducting element, i.e. at least one electric contact protruding, at least partly, from an inner side of at least one of the cuboidal elements. There may be embodiments that have conducting elements on both inner sides and/or that have a plurality of conducting elements. The connector body and/or the protruding cuboidal elements may be massive and/or may have cooling structure, for example cooling channels, e.g. as a passage for a cooling fluid.

The conducting element is configured for conducting the charging current. In at least some embodiments, the total charging current is distributed among a plurality of conducting elements. The conducting elements may comprise or consist of highly conducting material, such as copper, others or a conducting alloy, possibly with a highly conducting coating material, such as gold or silver. The conducting elements may be elastic, at least partly, to reduce an electric transition resistance to the conducting structure by exerting a pressure on the conducting structure.

The conducting element is arranged slidably between two notches, wherein the notches are arranged in the cuboidal element. The conducting element may be designed as an arc or as a U or similarly, so that each one of the ends of the arc (etc.) are able to engage into each one of the corresponding notches. For reducing an electric transition resistance between the conducting element and the corresponding notch, the conducting element may exert some pressure on the notches. Additionally or as an alternative, the conducting element and/or the corresponding notch may be coated with a material that reduces the electric transition resistance or contact resistance and/or improves the slidability. The end of the conducting element and the corresponding notch may have a corresponding form; for instance, both are rounded or rectangular, hexagonal, or of another form. Alternatively, end of the conducting element and the corresponding notch may have a form that enables “cutting” into the notch; for instance, the notch may have a rounded form, and the end of the conducting element may be rectangular. Both the conducting element and the notches are configured for conducting the charging current, thus enabling a transfer of high power to the corresponding conducting structure.

The design of the electric connector as described above and/or below may not only enable a transfer of high power between the connector and the corresponding conducting structure, e.g., by many means that reduce electric transition resistances. The design of the electric connector further improves the connector's maintainability and/or its serviceability, particularly because the slidably arranged conducting element(s) can easily be pulled out of the notches. Then, the conducting element(s) may be substituted or repaired. This may advantageously reduce the lifetime cost of the connector.

### BRIEF DESCRIPTION OF THE SEVERAL VIEWS OF THE DRAWING(S)

FIG. 1 is a diagram of an electric connector according to an embodiment of the present disclosure.

FIG. 2 is a diagram of a part of an electric connector according to an embodiment of the present disclosure.

FIG. 3 is a schematic representation of an element of an electric connector according to an embodiment of the present disclosure.

FIG. 4 is a schematic representation of an element of an electric connector according to an embodiment of the present disclosure.

FIG. 5 is a schematic representation of an electric connector according to an embodiment of the present disclosure.

FIG. 6 is a schematic representation of an electric connector according to an embodiment of the present disclosure.

FIG. 7 is a schematic representation of an electric connector according to an embodiment of the present disclosure.

FIG. 8 is a schematic representation of an electric connector according to an embodiment of the present disclosure.

### DETAILED DESCRIPTION OF THE INVENTION

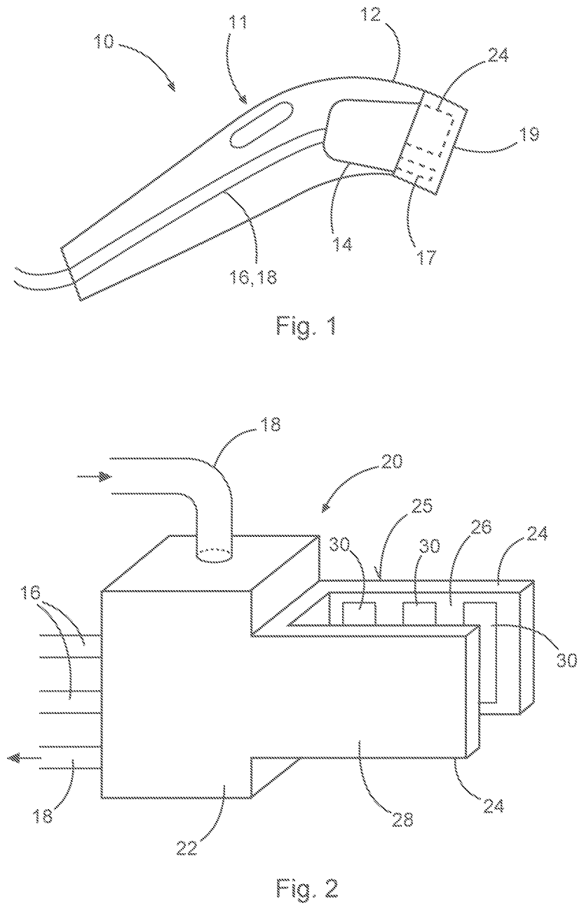

FIG. 1 shows schematically an electric connector 10 according to an embodiment. The connector 10 has a handle 11, which may help for plugging the connector 10 into a corresponding conducting structure (not shown), which may be arranged in or on an electric vehicle, on a mating face 19. The handle 11 may be part of an external enclosure 12 of the connector 10 and/or integrated into the external enclosure 12. The connector 10 shown further has a cable 16 and a fluid channel 18, for cooling fluid, inside the external enclosure 12. The cable 16 and the fluid channel 18 lead to an internal enclosure 14, which holds a connector core 22 (see, e.g., FIG. 2) and protruding cuboidal elements 24. The connector 10 may have further components, e.g., control or pilot pins 17 and/or further ones, which are neglected in this description.

FIG. 2 shows schematically a part of an electric connector 10—e.g., the one shown in FIG. 1—according to an embodiment. This part comprises a connector body 20, comprising a connector core 22, which is connected to cables 16 and fluid channels 18. The connector body 20 further comprises two protruding cuboidal elements 24, wherein the connector core 22 and the two protruding cuboidal elements 24 form a kind of U, particularly a rectangular U. The U may have rounded inner corners (not shown). Each of the cuboidal elements 24 has an outer side 28 and an inner side 26 and, further, an upper edge 25. In FIG. 2, there are—as an example—three conducting elements 30 visible, which are arranged at an inner side 26 of one of the protruding elements 24. The other protruding cuboidal element 24, whose inner side is not visible in FIG. 2, may also have conducting elements 30.

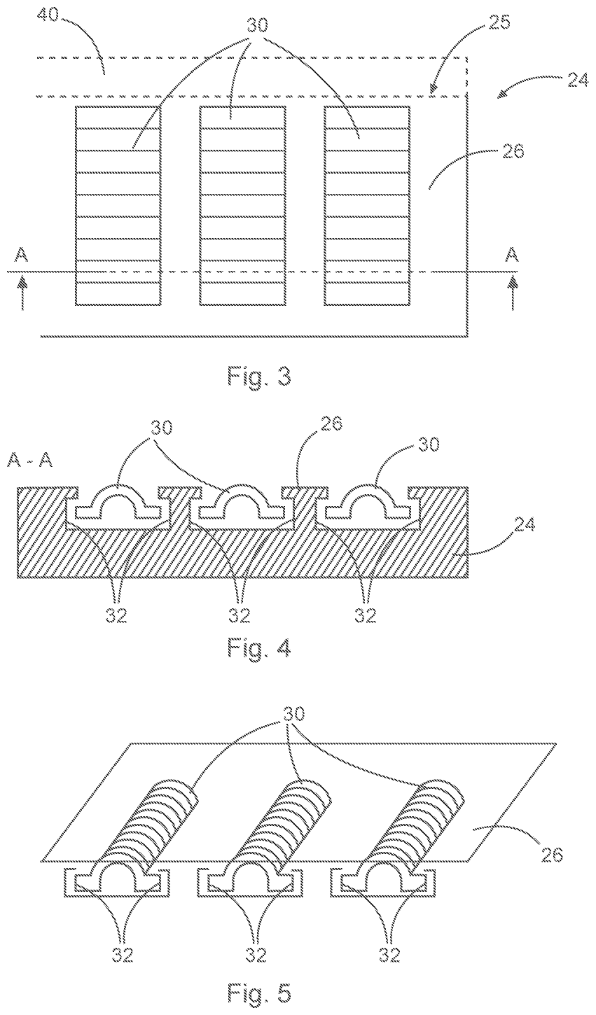

FIG. 3 shows schematically an element of an electric connector 10 according to an embodiment, namely a part of an inner side 26 of a protruding cuboidal element 24, where a plurality of conducting elements 30 are arranged. FIG. 3 further shows a detachable top element 40 (shown with dashed lines), which is arranged on top of an upper edge 25 of the cuboidal element 24. It can clearly be seen that the top element 40 “closes” the conducting elements 30 (more precisely: notches, where said conducting elements 30 can slide, see below). Thus, the top element 40 prevents the conducting element 30 from sliding out of the notches. Details of the notches are explained below.

FIG. 4 shows schematically an element of an electric connector 10 according to an embodiment, namely a longitudinal section A-A of FIG. 3. FIG. 4 shows that conducting elements 30 are arranged within notches 32, which are arrange in the cuboidal element 24. The notches 32 may be milled into the cuboidal element 24, or otherwise inserted into it. The notches 32 are part of an opening, which is open towards the inner side 26 of a protruding cuboidal element 24. The conducting elements 30 protrude partly from the inner side 26. When a corresponding conducting structure—e.g. of an electric vehicle— (not shown) is surrounded by the cuboidal elements 24, charging current may be transferred via the conducting elements 30 to the corresponding conducting structure. The conducting elements 30 may be elastic, so that some pressure is exerted on the conducting structure, thus reducing an electric transition resistance between the conducting elements 30 and the conducting structure. In this embodiment, the ends of the conducting elements 30 and the corresponding notches 32 have a corresponding form, i.e. both are formed rectangular, so that the conducting elements 30 can slide between the two notches 32. FIG. 5 shows a variation of the conducting elements 30. Their ends are formed as a shoe, so that they can slide between the two notches 32. The conducting elements 30 protrude partly from the inner side 26.

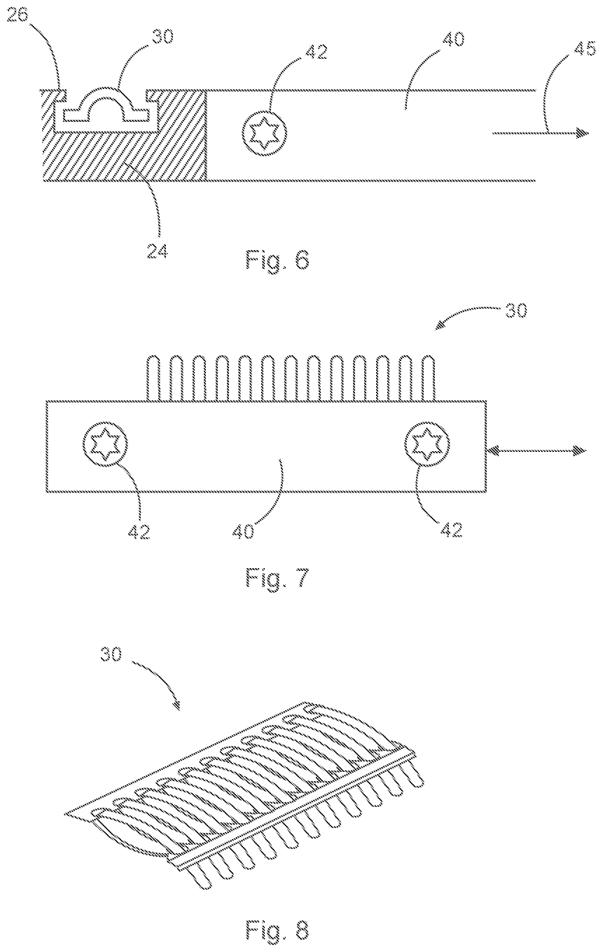

FIG. 6 shows schematically an element of an electric connector 10 according to an embodiment. Again, the conducting elements 30 are arranged slidably between two notches 32, the notches 32 arranged in the cuboidal element, and the conducting elements 30 protrude partly from the inner side 26. Furthermore, a detachable top element 40 is shown, which has been slid to the right (see arrow 45), to get access to the conducting elements 30. Before removing the detachable top element 40, a screw 42 had been loosened. After having detached the top element 40, the conducting elements 30 can be drawn out its holding notches 32. Then, the slidably arranged conducting elements can easily be pulled out of the notches 32. After that, the conducting elements 30 may be substituted or repaired.

FIG. 7 and FIG. 8 show schematically an element of an electric connector 10 according to an embodiment. In FIG. 7, the detachable element 40 is arranged at an outer end of the notches 32 and, thus, prevents the conducting element 30 from sliding out of the notches 32. In FIG. 8, a variation of the conducting element 30 is shown.

### LIST OF REFERENCE SYMBOLS

10 connector
11 handle
12 external enclosure
14 internal enclosure
16 cable
17 control/pilot pins
18 fluid channel
19 mating face
20 connector body
22 connector core
24 protruding cuboidal elements
25 upper edge
26 inner side
28 outer side
30 conducting element
32 notches
40 detachable top element
42 arranging structure
45 arrow

In various embodiments, the connector further comprises a detachable top element, wherein the detachable top element is arranged at an outer end of at least one of the notches, thus preventing the conducting element from sliding out of the notches. The design of the detachable top element may depend on the form of the notches. For instance, if the notches are designed with a dead end and open to an upper edge of the protruding cuboidal element, then the detachable top element may be arranged at the upper edge, thus covering the notches (or at least one of them) and preventing, by this arrangement, the conducting element from sliding out of the notches. In cases when the notches are designed with open ends on both sides, then one detachable top element may be arranged on each one of the open ends. Analogously, if the notches are designed with an open end towards the distal end of the connector body, then the detachable top element may be arranged on said distal end.

In various embodiments, the detachable top element is arranged by form-locking and/or force-locking structure, particularly by at least one of: a screw, a clip, a bayonet lock, a pin, a magnets, and/or by further structure.

In various embodiments, the connector core, the two protruding cuboidal elements and/or the detachable top element comprise or consist of copper, and conductive and/or protective outer coat. The materials may include several types of alloys. The notches may be of the same material as the protruding cuboidal elements, e.g. milled into the protruding cuboidal element.

In various embodiments, the connector core and/or the two protruding cuboidal elements contain channels for cooling fluid. The cooling fluid may be a non-conducting fluid. The cooling channels may advantageously further increase the power the connector is configured for.

In various embodiments, the connector core is formed as a cuboidal block or as a cylinder. This may advantageously improve the manner how the connector core is arranged inside the connector.

In various embodiments, the conducting element comprises or consists of at least one of: copper, steel, aluminum, and/or the conducting element is at least partly elastic. These properties may improve the electric conductivity and/or a transition resistance to the conducting structure and/or to the protruding cuboidal elements.

In various embodiments, the conducting element is coated with a material that reduces the electric transition resistance and/or improves the slidability, particularly with silver, silver-graphite composites, gold, rhodium, and/or similar materials.

In various embodiments, the notches are arranged in parallel and/or perpendicularly to an upper edge of the protruding cuboidal element. This may provide a high flexibility for individual designs of the connector, possibly within a prescribing norm.

In various embodiments, the connector comprises a plurality of conducting elements, and/or the conducting elements are arranged along the inner side of each one of the protruding cuboidal elements. Said plurality of conducting elements may contribute to enabling a transport of high power by the connector.

An aspect of the present disclosure also relates to a method of use of a connector as described above and/or below for high power charging, particularly of electric vehicles. The connector may be used for delivering a maximum current in a range of 3 kA and a maximum voltage of in the range of 1.5 kV. The connector may preferably be configured for delivering DC power.

For further clarification, the invention is described by means of embodiments shown in the figures. These embodiments are to be considered as examples only, but not as limiting.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A connector for high power electrical charging, comprising:
a connector body comprising a connector core and two protruding cuboidal elements, the connector core and the two protruding cuboidal elements forming a rectangular U shape, and
at least one conducting element arranged at an inner side of the protruding cuboidal element,
wherein the conducting element protrudes, at least partly, from the inner side, and wherein the conducting element is arranged slidably between two notches, the two notches being arranged in the cuboidal element,
wherein the conducting element and at least one notch of the two notches is configured for conducting charging current.

2. The connector of claim 1, further comprising a detachable top element connected to the connector body, wherein the detachable top element is arranged at an outer end of at least one of the two notches, and disposed to prevent the conducting element from sliding out of the two notches.

3. The connector of claim 2, wherein the detachable top element is releasably connected to the connector body by at least one of: a screw, a clip, a bayonet lock, a pin, and/or a magnet.

4. The connector of claim 1, wherein at least one of the connector core, the two protruding cuboidal elements, or the detachable top element comprises copper having an isolating outer coat.

5. The connector of claim 1, wherein at least one of the connector core or the two protruding cuboidal elements contains channels for a cooling fluid flow.

6. The connector of claim 1, wherein the connector core is formed as a cuboidal block.

7. The connector of claim 1, wherein the connector core is formed as a cylinder.

8. The connector of claim 1, wherein the conducting element comprises at least one of: copper, steel, or aluminum.

9. The connector of claim 1, wherein the conducting element is at least partly elastic.

10. The connector of claim 1, wherein the conducting element is coated with a material that reduces an electric transition resistance and improves slidability, particularly with gold, rhodium, silver, and/or silver-graphite composites.

11. The connector of claim 1, wherein the two notches are arranged in parallel to an upper edge of the protruding cuboidal element.

12. The connector of claim 1, wherein the two notches are arranged perpendicular to an upper edge of the protruding cuboidal element.

13. The connector of claim 1, wherein an end of the conducting element has a form that corresponds to a form of the notch, wherein the form is shaped as one of a rounded, a rectangular, or a hexagonal form.

14. The connector of claim 1, wherein the connector comprises a plurality of conducting elements, and wherein the plurality of conducting elements is arranged on an inner side of each one of the protruding cuboidal elements.

15. A method for high power charging of electric vehicles for delivering a maximum current of about 3 kA and a maximum voltage of about 1.5 kV using an connector, the method comprising:
providing a connector body comprising a connector core and two protruding cuboidal elements, the connector core and the two protruding cuboidal elements forming a rectangular U shape, and
arranging at least one conducting element at an inner side of the protruding cuboidal element,
wherein the conducting element protrudes, at least partly, from the inner side, and wherein the conducting element is arranged slidably between two notches, the two notches being arranged in the cuboidal element,
wherein the conducting element and at least one notch of the two notches is configured for conducting charging current.
